(19) United States
(12) Patent Application Publication
(10) Pub. No.: US 2018/0056285 A1
(43) Pub. Date: Mar. 1, 2018

(54) SYSTEM AND METHOD FOR CONTROL OF CONTAMINANTS WITHIN LABORATORY CONTAINMENT DEVICES

(71) Applicant: Halton Oy, Kausala (FI)

(72) Inventors: Kim HAGSTRÖM, Lahti (FI); Flemming Malcho, Dragoer (DK); Richard James Brown, Suffolk (GB)

(21) Appl. No.: 15/687,056

(22) Filed: Aug. 25, 2017

(30) Foreign Application Priority Data
Aug. 26, 2016 (EP) 16185882.4

(51) Int. Cl. B01L 1/02; B01L 1/04; B08B 15/02

(52) U.S. Cl. CPC B01L 1/025; B01L 1/04; B01L 2200/141; B01L 2200/143; B01L 2200/145; B08B 15/02

(57) ABSTRACT

The present invention provides a measured containment control system fitted to a laboratory containment device 1. These devices can have a variety of coherent enclosure configurations in terms of size and geometry. User access to these devices can be by means of either an opening or the use of gloves with, in this latter case, typically filtration of the intake and exhaust ventilation. The system comprises further at least one sensor 6, an exhaust duct 5 or exhaust outlet connected to the laboratory containment device 1 for ventilation, an air flow control means 2 for controlling the exhaust air volume in the exhaust duct 5 and a control unit 13 connected to at least one sensor 6 and to the air flow control means 2. The control unit 13 is arranged to receive signals from at least one sensor 6 constantly and adjusting, based on these signals, the air flow control means 2 to change the exhaust air volume from the laboratory containment device 1.

### FIELD OF THE INVENTION

The present invention relates to a system for the control of contaminants within laboratory containment devices.

### BACKGROUND OF THE INVENTION

In laboratories processes including hazardous activities and those requiring clean conditions are carried out in ventilated containment devices described as fume cupboards, fume hoods, biological safety cabinets, isolators, chemical storage cabinets and other forms of local exhaust ventilation (LEVs). These devices can have variety of coherent enclosure configurations in terms of size and geometry. User access to these devices can be by means of either an opening or the use of gloves with, in this latter case, typically filtration of the intake and exhaust ventilation. For the remainder of this document these various types and groups of devices will be referenced as laboratory containment devices. The ventilation exhausts of these devices are set to either constant or variable rates on the basis of predetermined estimations or analysis of the functional requirements that include worst case safety considerations. That is, control of the exhaust ventilation potentially has deficiencies in terms of both energy efficiency and responses to hazardous conditions. For situations in which numbers of these devices are installed this approach also has considerable implications in terms of the capital costs of the ventilation systems.

For laboratory containment devices having user access by means of an opening and being equipped with conventional variable air volume control (VAV) a variety of forms of control is available. All share the general concept of increasing the volume flow rate drawn through the opening as the movable sash is opened with the objective that the face velocity (of the opening) remains essentially the same at a range of positions (of the sash).

The types of ventilation control device include:
Modulating dampers (being currently the most commonly used approach).
Two-position switching (dampers).
Two-speed switching (fans).

The varieties of control sensor format can include:
Sash position sensing.
Hot wire anemometers.
Pressure/flow measurements.

Irrespective of the combination of control device and sensor format adopted, these arrangements all share the common characteristic of being open-loop or feed-forward in concept. That is, rather than controlling against measurements of the level of contaminants within a laboratory containment device (the reduction/removal of which is the central objective) the operational criteria are the availability of a predetermined volume flow rate, a face velocity, and a maximum VAV turndown ratio. Such fixed performance metrics (whether empirically set, assessed, or evaluated) cannot respond fully to the linked requirements of functional safety and sustainability.

### OBJECTIVE OF THE INVENTION

The objective of the invention is to alleviate the disadvantages mentioned above.

In particular, it is an objective of the present invention to provide an energy efficient ventilation system for laboratory containment devices while simultaneously meeting safety objectives.

The invention described in this application is the replacement of the ventilation control arrangements described above by an alternative in which the internal conditions of the containment devices are measured for contamination and in which the ventilation exhaust rate is varied to control (reduce or eliminate) the levels of contamination. This invention is herein after referred to as Measured Containment Control (MCC).

### SUMMARY OF THE INVENTION

According to a first aspect, the present invention provides a measured containment control system comprising a laboratory containment device having a coherent enclosure intended to contain potentially hazardous materials or activities of those requiring clean conditions. The system comprises further at least one sensor arranged to measure properties in the air, an exhaust outlet for ventilation of the laboratory containment device, at least one opening for the supply air to enter inside the laboratory containment device, an air flow control means for controlling the exhaust air volume and a control unit connected to at least one sensor and to the air flow control means. The control unit is arranged to receive signals from at least one sensor constantly and adjusting, based on these signals, the air flow control means to change the exhaust air volume from the laboratory containment device.

In an embodiment of the invention, at least one sensor is arranged to measure chemical, pathogenic, radiological, or particulate content in the air. It is understood that there are other possible properties in the air which the sensor may be arranged to measure such as air temperature or humidity, which may be critical for the working safety or working conditions.

In an embodiment of the invention, the system comprises two or more sensors, which are arranged to measure one or several properties in the air.

In an embodiment of the invention, the exhaust outlet comprises an exhaust duct, which is connected to the laboratory containment device, and one sensor is arranged inside the exhaust duct.

In an embodiment of the invention, one sensor is arranged inside the laboratory containment device.

In an embodiment of the invention, one sensor is arranged outside of the laboratory containment device. The location in this case may be for example near the means for user to access inside the laboratory containment device, or inside the ventilation system of the room in which the laboratory containment device is.

In an embodiment of the invention, sensors are arranged in several locations inside or outside of the laboratory containment device. Again the location of the sensors outside of the laboratory containment device may be for example near the means for user to access inside the laboratory containment device, or inside the ventilation system of the room in which the laboratory containment device is.

In an embodiment of the invention, the means for user to access inside the containment device comprises at least one movable sash, door or window which reveals and adjusts the size of opening for accessing inside the laboratory containment device. The size and geometry of the sash, door or window may vary depending of the size of the opening. Also the sash, door or window may comprise sliding mechanism or they may be connected to the laboratory containment device by hinges.

In an embodiment of the invention, one sensor detects the position of the sash, door or window.

In an embodiment of the invention, one sensor measures the face velocity in the opening.

According to a second aspect of the invention, the present invention provides a method for measured containment control comprising a measured containment control system comprising a laboratory containment device having a coherent enclosure intended to contain potentially hazardous materials or activities or those requiring clean conditions. The system comprises further at least one sensor arranged to measure properties in the air, an exhaust outlet for ventilation, at least one opening for the supply air to enter inside the laboratory containment device, an air flow control means for controlling the exhaust air volume and a control unit connected to at least one sensor and to the air flow control means. The control unit is arranged to receive signals from at least one sensor constantly and adjusting, based on these signals, the air flow control means in order to change the exhaust air volume of in the laboratory containment device. At least one sensor, the control unit and the air flow control means forms closed-loop system so that at least one sensor constantly measures properties in the air inside the exhaust duct, inside of the laboratory containment device or outside of the laboratory containment device and sends signals to the control unit, which adjusts, based on these signals, the air flow control means in order to change the exhaust air volume from the laboratory containment device.

In an embodiment of the invention, at least one sensor measures chemical, pathogenic, radiological, or particulate content in the air.

In an embodiment of the invention, two or more sensors measure one or several properties in the air.

In an embodiment of the invention, one sensor measures the properties of the air in the exhaust outlet, inside of the laboratory containment device or outside of the laboratory containment device.

In an embodiment of the invention, other sensors measure the properties in the air in the exhaust outlet, inside the laboratory containment device or outside of the laboratory containment device.

In an embodiment of the invention, the means for user to access inside the laboratory containment device comprises at least one movable sash, door or window which is used to reveal and adjust the opening for accessing inside the laboratory containment device.

In an embodiment of the invention, one sensor detects the position of the sash, door or window.

In an embodiment of the invention, one sensor measures the face velocity in the opening. The opening may be connected to the opening to user to access inside the device or the opening may be separate one.

In an embodiment of the invention, first the position of the sash, door or window is measured and a first signal from the sensor is send to the control unit, which adjusts, based on the first signal, the air flow control means to change the exhaust air volume from the laboratory containment device; second the properties in the air is measured by another sensor and a second signal is send to the control unit, which adjusts, based on the second signal, the air flow control means again to change the exhaust air volume from the laboratory containment device.

In an embodiment of the invention, first the face velocity in the opening is measured and a first signal from the sensor is send to the control unit, which adjusts, based on the first signal, the air flow control means to change the exhaust air volume from the laboratory containment device; second the properties in the air is measured by another sensor and a second signal is send to the control unit, which adjusts, based on the second signal, the air flow control means to change the exhaust air volume from the laboratory containment device.

It is to be understood that the aspects and embodiments of the invention described above may be used in any combination with each other. Several of the aspects and embodiments may be combined together to form a further embodiment of the invention.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 shows axonometric front view of the laboratory containment device,

FIG. 2 shows axonometric side view of the laboratory containment device, and

FIG. 3 shows a measurement containment control system in a room.

### DETAILED DESCRIPTION OF THE INVENTION

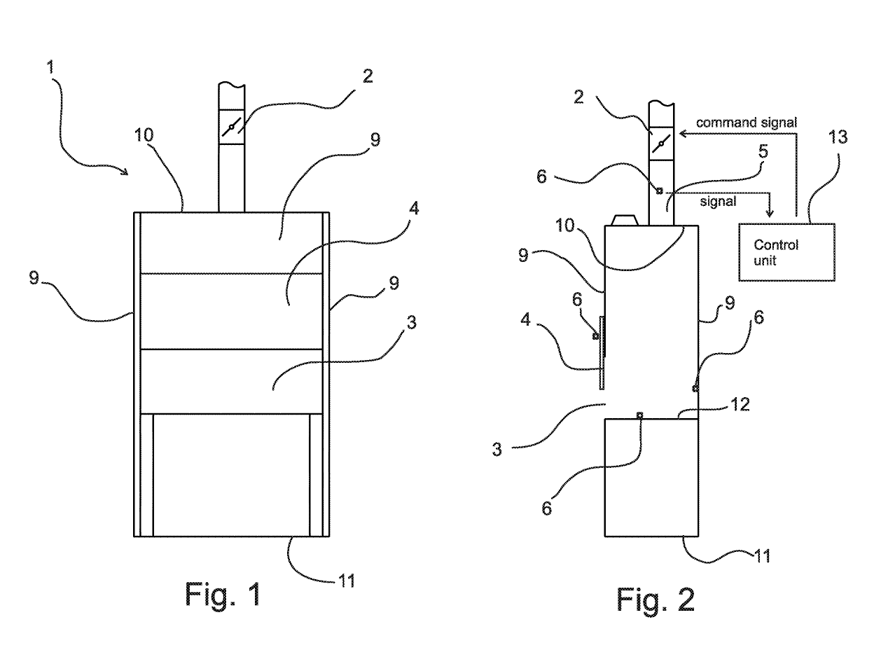

FIG. 1 shows a laboratory containment device 1 comprising four side walls 9, a ceiling 10, a floor 11, an exhaust outlet comprising an exhaust duct 5, and means for user to access inside the laboratory containment device. The exhaust duct 5 further comprises an air flow controlling means 2 for adjusting the volume of air flow from the laboratory containment device 1. In FIG. 1, the means for user to access inside the laboratory containment device 1 comprises a movable panel most typically termed a sash, but the user access may also be achieved by multiple smaller panels (doors, windows etc.) or sashes (sometimes positioned on more than one of the faces of the laboratory containment device) or by means of gloves or gauntlets. In FIG. 1 the sash 4 is shown in an open position revealing the opening 3 for user to access inside the laboratory containment device 1. A user 8, i.e. laboratory worker, operates inside the laboratory containment device 1 through the opening 3 and the user 8 may adjust the sash position to correspond to their needs. For example in emergency situations (e.g. a spillage of potentially harmful materials) it is important to close the opening 3 as fast as possible by closing the sash and set the exhaust air volume at maximum rate.

FIG. 1 shows only one possible structure for a laboratory containment device. It is understood that laboratory containment device includes many kind of devices which uses local exhaust ventilation and are arranged in a room, such as fume cupboards, fume hoods, microbiological safety cabinets and chemical storage cabinets. Therefore, it is understood that the device may have many structural forms like having no floor (e.g. walk-in unit), having different number of side walls and/or having curved surfaces etc., as long as the properties in the air inside the laboratory containment device can be measured and controlled.

FIG. 2 shows a side view of the laboratory containment device 1, which comprises at least one sensor 6. The sensor 6 is arranged to measure constantly properties in the air such as chemical, pathogenic, radiological, or particulate content. In FIG. 2, sensors 6 are placed inside the exhaust duct 5, on the back wall of the operating area inside the laboratory containment device 1, on the working plane 12 and on the sash outside of the laboratory containment device 1. These are only possible locations for the sensors 6 and it is understood that the location may be elsewhere inside the laboratory containment device 1 or near the laboratory containment device 1. There may also be several sensors 6 to measure the same feature or they may measure different properties in the air. The sensor 6 sends signals constantly to a control unit 13, which calculates if there is a need to increase or decrease the exhaust air volume by adjusting air flow control means 2. This is called closed-loop system, wherein the control unit 13 gets feedback from the sensor 6 and compares the result with the desired value. If the measured value differs from the desired value, the control unit sends command signal to the air flow control means to adjust the exhaust air volume to reach the desired value. If the measured value does not differ from the desired value, the exhaust air volume is possible to decrease near to zero or even to zero to save energy. This would not be possible without the measured containment control (MCC) system, which constantly measures contaminant level in the air and adjusts the exhaust air volume when needed. The air flow control means 2 is typically a damper, which position can be adjusted. Other typically used air flow control means 2 are switches having different positions, and fans having adjustable speed. It is understood that the means may comprise other devices to adjust the exhaust air volume from the laboratory containment device 1.

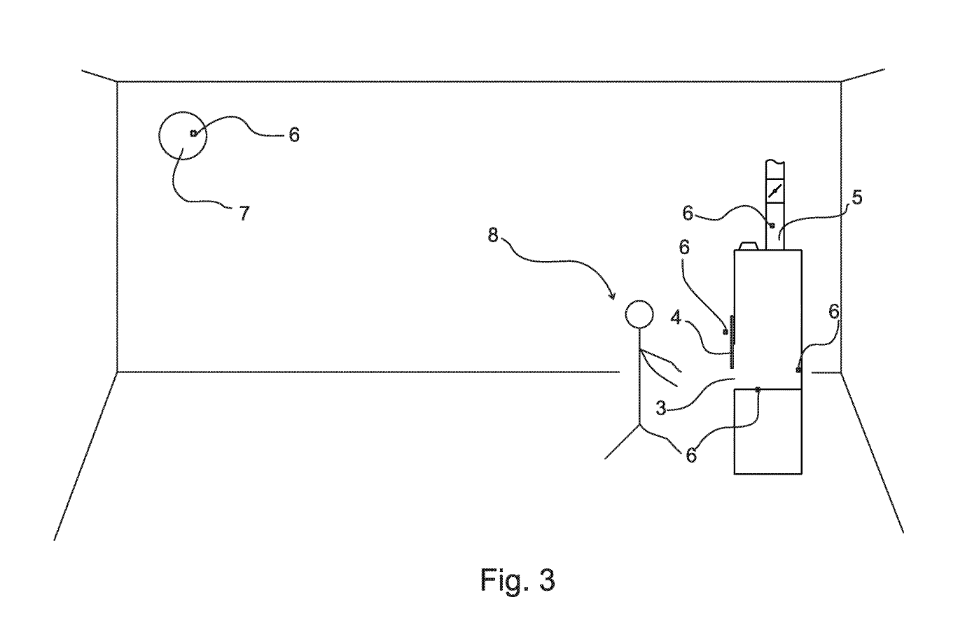

FIG. 3 discloses a room comprising a measured containment control system and a user 8 operating at the laboratory containment device 1. In FIG. 3 the room comprises one laboratory containment device 1 but it is possible to have several laboratory containment devices 1 in one room. Each laboratory containment device 1 comprises at least one sensor 6 to measure properties in the air inside or near the laboratory containment device 1. The room comprises independent air ventilation system comprising at least one fresh supply air duct 7. The measured containment control system may comprise a sensor 6 also inside the fresh supply air duct. It is possible to use the values measured inside the fresh supply air duct 7 as a reference value and compare this value with the values measured inside or near the laboratory containment device 1, and adjust the exhaust air volume if these values don't correspond to each other.

In figures, the exhaust duct 5 is connected to the laboratory containment device through the ceiling 10. However, it may be connected to the laboratory containment device 1 through other surfaces of its enclosure. Also the laboratory containment device is only one possible application wherein the system can be used. The system may be used in various laboratory processes which require clean conditions and hazardous materials are used, and the types of laboratory containment device to which the invention may be applied include fume cupboards, fume hoods, microbiological safety cabinets, isolators, chemical storage cabinets and other forms of local exhaust ventilation. Some of these containment devices have a user interface by means of gloves or gauntlets rather than an opening but the application of the invention and its benefits in terms of safety and energy efficiency remain achievable.

Although the invention has been the described in conjunction with a certain type of system, it should be understood that the invention is not limited to any certain type of system. While the present inventions have been described in connection with a number of exemplary embodiments, and implementations, the present inventions are not so limited, but rather cover various modifications, and equivalent arrangements, which fall within the purview of prospective claims.

1. A measured containment control system comprising
a laboratory containment device having a coherent enclosure;
means for user to access inside the laboratory containment device;
at least one sensor arranged to measure properties in the air;
an exhaust outlet for ventilation of the laboratory containment device;
at least one opening for the supply air to enter inside the laboratory containment device;
an air flow control means for controlling the exhaust air volume;
a control unit connected to at least one sensor and to the air flow control means
wherein the control unit is arranged to receive signals from at least one sensor constantly and adjusting, based on these signals, the air flow control means to change the exhaust air volume from the laboratory containment device so that the exhaust air volume is arranged to be decreased when the measured value is desired.

2. A measured containment control system according to claim 1, wherein at least one sensor is arranged to measure chemical, pathogenic, radiological, or particulate content in the air.

3. A measured containment control system according to claim 1, wherein the system comprises two or more sensors, which are arranged to measure one or several properties in the air.

4. A measured containment control system according to claim 1, wherein the exhaust outlet comprises an exhaust duct and one sensor is arranged inside the exhaust duct.

5. A measured containment control system according to claim 1, wherein one sensor is arranged inside the laboratory containment device.

6. A measured containment control system according to claim 1, wherein one sensor is arranged outside of the laboratory containment device.

7. A measured containment control system according to claim 3, wherein sensors are arranged in several locations inside or outside of the laboratory containment device.

8. A measured containment control system according to claim 1, wherein the means for user to access inside the containment device comprises at least one movable sash, door or window.

9. A measured containment control system according to claim 8, wherein one sensor detects the position of the sash, door or window.

10. A measured containment control system according to claim 1, wherein one sensor measures the face velocity in the opening.

11. A method for measured containment controlling comprising a system according to claim 1, wherein at least one sensor, the control unit and the air flow control means forms closed-loop system so that at least one sensor constantly measures properties in the air inside the exhaust outlet, inside of the laboratory containment device or outside of the laboratory containment device and sends signals to the control unit, which adjusts, based on these signals, the air flow control means to change the exhaust air volume from the laboratory containment device.

12. A method for measured containment controlling comprising a method according to claim 11, wherein at least one sensor measures chemical, pathological, radiological, or particulate content in the air.

13. A method for measured containment controlling comprising a method according to claim 11, wherein two or more sensors measure one or several properties in the air.

14. A method for measured containment controlling comprising a method according to claim 11, wherein one sensor measures the properties in the air in the exhaust outlet, inside of the laboratory containment device or outside of the laboratory containment device.

15. A method for measured containment controlling comprising a method according to claim 14, wherein other sensors measures the properties in the air in the exhaust outlet, inside of the laboratory containment device or outside of the laboratory containment device.

16. A method for measured containment controlling comprising a method according to claim 11 wherein the means for user to access inside the laboratory containment device comprises at least one movable sash, door or window which is used to reveal and adjust the opening for accessing inside the laboratory containment device.

17. A method for measured containment controlling comprising a method according to claim 16, wherein one sensor detects the position of the movable sash, door or window.

18. A method for measured containment controlling comprising a method according to claim 11, wherein one sensor measures the face velocity in the opening.

19. A method for measured containment controlling comprising a method according to claim 17, wherein first the position of the sash, door or window is measured and a first signal from the sensor is send to the control unit, which adjusts, based on the first signal, the air flow control means to change the exhaust air volume from the laboratory containment device; second the properties in the air is measured by another sensor and a second signal is send to the control unit, which adjusts, based on the second signal, the air flow control means to change the exhaust air volume from the laboratory containment device.

20. A method for measured containment controlling comprising a method according to claim 18, wherein first the face velocity in the opening is measured and a first signal from the sensor is send to the control unit, which adjusts, based on the first signal, the air flow control means to change the exhaust air volume from the laboratory containment device; second the properties in the air is measured by another sensor and a second signal is send to the control unit, which adjusts, based on the second signal, the air flow control means to change the exhaust air volume from the laboratory containment device.
